(19) United States
(12) Patent Application Publication
(10) Pub. No.: US 2010/0067153 A1
(43) Pub. Date: Mar. 18, 2010

(54) System utilizing a ground fault circuit interrupter (GFCI) as a remote controlled protection device

(76) Inventors: Robert Price Vellines, Lake Station, IN (US); Judith Louise Vellines, Lake Station, IN (US)

Correspondence Address: Robert Vellines, JR, 3668 Florida St., Lake Station, IN, 46405, US

(21) Appl. No.: 12/557,740

(22) Filed: Sep. 11, 2009

Related U.S. Application Data
(60) Provisional application No. 61/096,079, filed on Sep. 11, 2008.

(51) Int. Cl. H02H 3/00

(52) U.S. Cl. 361/42

(57) ABSTRACT

A system utilizing a ground fault circuit interrupter (GFCI) as a remote controlled protection device includes: a sensor adapted to detect a problem in the load; a switch adapted to generate an electrical signal when the sensor detects the problem; and an electrical interconnection adapted to provide the electrical signal to the ground fault circuit interrupter. In response to the electrical signal, the ground fault circuit interrupter initiates the trip function, thereby protecting the load.

### RELATED APPLICATIONS

The present application claims benefit of priority from U.S. Provisional Application No. 61/096,079, filed Sep. 11, 2008, which is incorporated herein by reference in its entirety.

### BACKGROUND OF THE INVENTION

The present invention generally relates to electrical circuits, and more specifically, to a system utilizing a ground fault circuit interrupter (GFCI) as a remote controlled protection device.

In a home or other wiring system, a ground fault circuit interrupter (GFCI) operates by monitoring electricity flowing in a circuit, to sense any loss of current. If the current flowing through the circuit differs from the returning current, the GFCI trips, switching off power to that circuit. A GFCI will have a test button to manually trip the GFCI, and a reset button to manually return the GFCI to an operational state.

Currently, a properly installed standard GFCI is unable to be controlled and tripped by remote sensors or any other electrical or electronic monitoring circuits.

As can be seen, there is a need for a way to trip a GFCI remotely, so the GFCI can be used as a remote-controlled safety device.

### SUMMARY OF THE INVENTION

In one aspect of the present invention, a device for protecting a load utilizing a ground fault circuit interrupter having a trip function includes: a sensor adapted to detect a problem in the load; a switch adapted to generate an electrical signal when the sensor detects the problem; and an electrical interconnection adapted to provide the electrical signal to the ground fault circuit interrupter; wherein, in response to the electrical signal, the ground fault circuit interrupter initiates the trip function, thereby protecting the load.

In another aspect of the present invention, a method for remotely protecting a load includes: driving the load with an electric circuit; utilizing a ground fault circuit interrupter adapted to interrupt the electric circuit; detecting a problem in the load; providing a remote signal to the ground fault circuit interrupter in response to detecting the problem; and in response to receiving the remote signal, interrupting the circuit, thereby protecting the load.

These and other features, aspects and advantages of the present invention will become better understood with reference to the following drawings, description and claims.

### BRIEF DESCRIPTION OF THE DRAWINGS

FIG. 1 depicts an embodiment of the present invention;

FIG. 2 depicts a first embodiment of electrical interconnection according to the present invention;

FIG. 3 depicts a second embodiment of electrical interconnection according to the present invention; and

FIG. 4 depicts a third embodiment of electrical interconnection according to the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a remotely controlled protection device for a ground fault circuit interrupter (GFCI).

In an embodiment of the present invention, when a problem is detected or sensed by a remote sensor or any other electrical or electronic monitoring circuit, an electrical signal is created and sent to the properly installed standard GFCI that mimics manually pressing the test button on the GFCI causing it to trip.

An embodiment adds a new safety feature to the already existing safety features of a GFCI to allow remote sensor(s) and/or any other electrical/electronic monitoring circuit(s) to control and trip a properly installed standard GFCI. This is in addition to and generally does not interfere with the already-existing safety features provided by the GFCI.

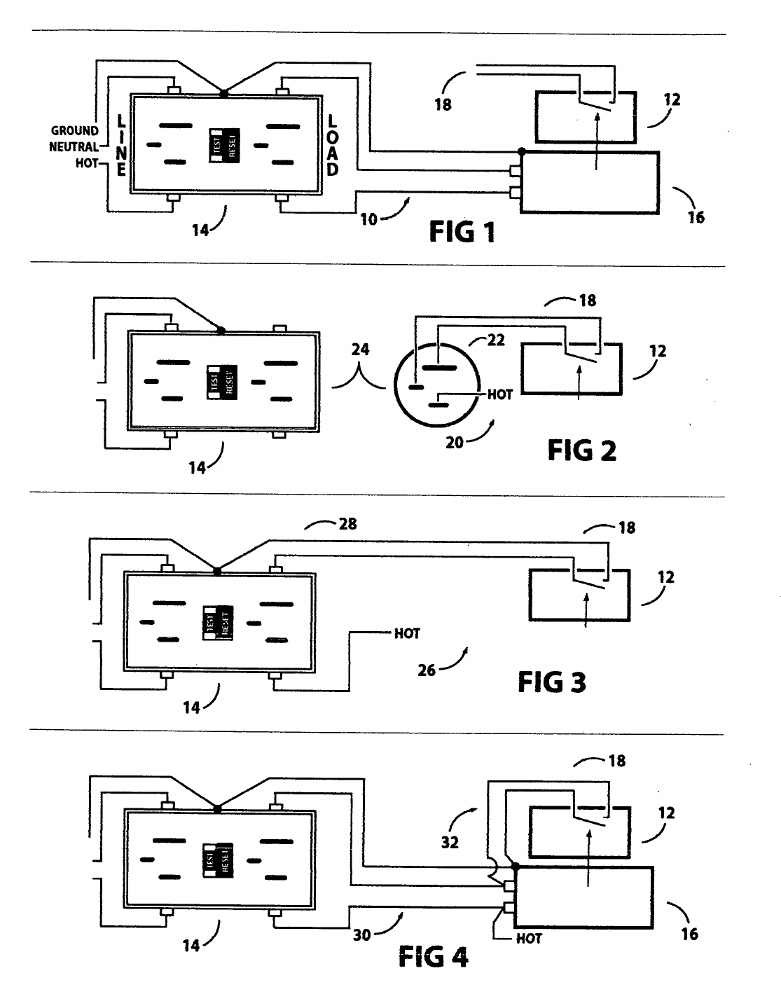

As depicted in FIG. 1, an embodiment 10 of the present invention may include remote sensor controlled switch contacts 12, a ground fault circuit interrupter 14, a load 16, and an electrical interconnection 18. The remote sensor controlled switch contacts 12 may be any device (electrical/electronic circuit, mechanical, or other) created, designed, adapted, or modified to monitor a load 16 and create an electrical signal by closing its controlled switch contacts 12 when a problem is detected or sensed in the monitored load 16. The ground fault circuit interrupter 14 may be an existing standard and properly installed electrical safety device providing all of its designed safety features to the load 16. The load 16 may be any process, activity, equipment, or device connected to, receiving power from, and protected by the GFCI 14. The general electrical interconnection 18 as depicted in FIG. 1 may be two wires or any other form of electrical or electronic communication that connects the remote sensor controlled switch contacts 12 to the GFCI 14.

The GFCI controls the power to the load 16 and receives or detects an electrical signal or condition from the remote sensor controlled switch contacts 12 via the appropriate method of electrical interconnection 18 to the GFCI 14 when a problem is detected or sensed in the load 16.

In the embodiment of FIG. 1, the ground fault circuit interrupter 14 provides and controls the power to the load 16. The remote sensor controlled switch contacts 12 create an electrical signal or an electrically detectable condition (the switch contacts 12 close creating an electrical short—zero ohms) when a problem is detected or sensed in the monitored load 16. This switch created signal is sent to the load side of the GFCI via the designated method of electrical interconnection as shown in FIGS. 2, 3, and 4. This signal mimics manually pressing the test button on the GFCI. The GFCI immediately trips, removes the power to, and stops the load 16. There are not necessarily any limitations on the distance between switch contacts 12 and the GFCI 14.

FIG. 2 depicts an embodiment 20 of an electrical interconnection that may include a safety plug 22 and a detachable connection 24 for the electrical interconnection 18 of FIG. 1. The safety plug 22 may be a standard AC electrical 3-blade (prong) safety plug. The detachable connection 24 utilizes a detachable method of the connecting electrical interconnection from switch contacts 12 to the proper blades (prongs) on safety plug 22 and safety plug 22 inserted into one of the GFCI 14 protected receptacles.

Either one of the two wires from switch contacts 12 is attached to the neutral blade (prong) on safety plug 22 and the other wire is attached to the safety ground blade (prong) on safety plug 22. The load 16 (not shown in FIG. 2) is connected to the GFCI 14 as shown in FIG. 1.

FIG. 3 depicts an embodiment 26 of an electrical interconnection that may include a permanent connection 28. A permanent method of the electrical interconnection from switch contacts 12 includes wires to the proper load terminals on the GFCI 14.

Either one of the two wires from the switch contacts 12 is attached to the GFCI load neutral terminal (white wire) and the other wire is attached to the GFCI safety ground terminal (green wire) during installation. The load 16 (not shown in FIG. 3) is connected to the GFCI 14 as shown in FIG. 1.

FIG. 4 depicts an embodiment 30 of an electrical interconnection that may include a load connection 32 to the electrical interconnection 18 of FIG. 1. A direct-to-load connection 32 of the electrical interconnection from switch contacts 12 to the proper leads from GFCI 14 is made utilizing the electrical connections at the load 16.

Either of the 2 wires from the switch contacts 12 is attached to the GFCI load neutral (white wire) and the other wire is attached to the GFCI safety ground (green wire) at the load 16.

The operation of an embodiment of this system does not necessarily require a connection to the GFCI load hot terminal (black wire) to function. However, it could be used to power the remote sensor(s) and/or any other electrical/electronic monitoring circuit(s) by adding a hot (black wire) to the electrical interconnection. This is shown in FIG. 2 attached to the hot blade (prong) on safety plug 22, in FIG. 3 attached to the load terminal (black wire) on the GFCI 14, or in FIG. 4 attached to the hot (black wire) at the load 16. This hot (black wire) is protected by the GFCI 14 in the same manner as any other properly installed load.

In an embodiment, to restore normal operation, after the problem has been corrected, the reset button on the GFCI may be manually pressed at the installed location of the GFCI regardless of the location of the load or switch contacts.

An embodiment of the present invention may be made by connecting the power leads for the load to the GFCI load terminals. The appropriate remote sensor controlled switch contacts to monitor the load are selected and installed at the chosen location. The switch contacts are connected to the load terminals of the same GFCI using electrical interconnection and the chosen method of connection.

The function performed by an embodiment of the invention may be wholly or partially performed, implemented, or executed by a machine or computer if the machine or computer can provide the proper electrical signal to the GFCI, or physically press the test button on the GFCI when a problem is detected or sensed in the load.

In an embodiment of the present invention, for example, in an attempt to prevent either human entrapment at a swimming pool/spa circulation intake grate or pump motor damage, an embodiment is used to monitor the flow of water in a swimming pool/spa circulation system for a problem. The pump motor is the load 16, which would be connected to and receive power from a protecting GFCI. The sensor with switch contacts 12 would be selected and mounted on the intake line of the circulation pump. The switch contacts 12 would utilize the electrical interconnection 18 to become electrically connected to the same GFCI as the pump motor by using the interconnection method of choice. When a problem occurs, the suction vacuum in the intake line would increase and cause the sensor switch contacts 12 to close (creating an electrical short—zero ohms) and send the signal to the GFCI via electrical interconnection 18 and a connection 24, 28 or 32. This signal mimics manually pressing the GFCI test button causing it to trip and immediately stop the pump motor preventing either human entrapment at the intake grate or pump motor damage.

Embodiments of the present invention may be used in any situation or field where it is desired to use a basic feedback system to monitor and control a GFCI installation. It can be used as a stand-alone emergency shutoff switch to prevent human injury or equipment damage in a GFCI installation. It can also be a simple and potentially inexpensive add-on to provide the remote safety shutoff feature to an existing GFCI installation.

It should be understood, of course, that the foregoing relates to exemplary embodiments of the invention and that modifications may be made without departing from the spirit and scope of the invention as set forth in the following claims.

We claim:

1. A device for protecting a load utilizing a ground fault circuit interrupter having a trip function, the device comprising:
a sensor adapted to detect a problem in the load;
a switch adapted to generate an electrical signal when the sensor detects the problem; and
an electrical interconnection adapted to provide the electrical signal to the ground fault circuit interrupter;
wherein, in response to the electrical signal, the ground fault circuit interrupter initiates the trip function, thereby protecting the load.

2. The device of claim 1, further comprising:
a safety plug;
wherein the electrical interconnection is electrically coupled to the ground fault circuit interrupter utilizing a detachable connection that connects to the safety plug.

3. The device of claim 1, wherein the electrical interconnection is fixedly, electrically coupled to the ground fault circuit interrupter utilizing wires.

4. The device of claim 1, the load having an electrical load connector, wherein the electrical interconnection is electrically coupled to the ground fault circuit interrupter utilizing the electrical load connector.

5. The device of claim 1, the ground fault circuit interrupter having a test button that uses a test button interface to initiate the trip function, wherein the electrical interconnection is electrically coupled to the test button interface.

6. A method for remotely protecting a load, comprising
driving the load with an electric circuit;
utilizing a ground fault circuit interrupter adapted to interrupt the electric circuit;
detecting a problem in the load;
providing a remote signal to the ground fault circuit interrupter in response to detecting the problem; and
in response to receiving the remote signal, interrupting the circuit, thereby protecting the load.

7. The method of claim 6, the ground fault circuit interrupter having a test function triggered by an input, wherein the remote signal provides the input to the test function, thereby interrupting the electric circuit.

8. The method of claim 6, further comprising:
providing a safety plug; and
electrically coupling the safety plug to the ground fault circuit interrupter utilizing a detachable connection; and
providing the remote signal to the ground fault circuit interrupter through the safety plug and the detachable connection.

9. The method of claim 6, further comprising:
electrically coupling the electrical interconnection to the ground fault circuit interrupter utilizing wires so as to produced a fixed, electrical connection.

10. The method of claim 6, the load having an electrical load connector, further comprising:
electrically coupling the electrical interconnection to the ground fault circuit interrupter utilizing the electrical load connector.
